(19) United States
(12) Patent Application Publication
(10) Pub. No.: US 2009/0017884 A1
(43) Pub. Date: Jan. 15, 2009

(54) METHOD AND SYSTEM FOR USING A CELLULAR PHONE IN WATER ACTIVITIES

(76) Inventor: Carmel Rotschild, Haifa (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/162,821

(22) PCT Filed: Mar. 8, 2007
(86) PCT No.: PCT/IL07/00299

§ 371 Date: Sep. 18, 2008

(30) Foreign Application Priority Data
Mar. 9, 2006 (IL) 174211

(51) Int. Cl. H04M 1/00

(52) U.S. Cl. 455/575.8

(57) ABSTRACT

The present invention relates to a method and system for carrying out water activities under or above water, comprising: (a) a cellular phone for enabling a user to carry out water activities; (b) a waterproof case having a front section and a back section, said waterproof case being suitable to contain said cellular phone, said back section comprising a control button(s) panel, including one or more control buttons, for remotely controlling said cellular phone; and (c) an electronic circuit, programmed according to the cellular phone type, for processing data for controlling said cellular phone by means of said one or more control buttons and for forwarding said data to said cellular phone, said electronic circuit communicating with both said cellular phone and said control button(s) panel.

### FIELD OF THE INVENTION

The present invention relates to water activities and more particularly, the invention relates to a method and system for acquiring underwater photographs and video films, communicating and navigating under or above water by means of a cellular phone.

### DEFINITIONS, ACRONYMS AND ABBREVIATIONS

Throughout this specification, the following definitions are employed:

Firmware: is operational software of an electronic device, which is embedded in said device. The firmware usually can be continuously improved and optimized for using hardware resources of said device for specific purposes.

Plug-in: is a computer program that can, or must, interact with another program to provide a certain, usually very specific, function. Typical examples are plug-ins for displaying specific graphic formats, to play multimedia files, to encrypt/decrypt emails, or to filter images in graphic programs. The main program provides a way for plug-ins to register themselves with the program, and with a protocol by which data is exchanged with said plug-ins.

### BACKGROUND OF THE INVENTION

For the last ten years, cellular phones market has expended significantly. Almost everyone now has his own cellular phone, and often more than one. It is very simple to use the cellular phone, allowing even to small children to utilize it without any problems. In addition, in the last years, have been introduced cellular phones comprising various features, such as photo and video cameras, GPS (Global Positioning System) means, etc. These cellular phones are successfully acquired by consumers and have great commercial success in business and private sectors. Many consumers are used to take photographs and to shoot video films by means of their cellular phones rather than by conventional photo and video cameras. In addition, navigation by means of GPS via cellular phones is becoming more and more popular in the everyday life. Various sport and amateur water activities require navigating above and under the water, taking photographs and/or shooting video-film. However, the prior art fails to utilize cellular phones capabilities for transmitting photographs, video films, voice and text messages under the water, and for navigating under the water by means of the cellular phone.

Like any other electronic device, a cellular phone is sensitive to the water and must be kept away from the water to be protected from damage. Therefore, a number of solutions have been proposed, providing nylon waterproof cases in which cellular phones have to be inserted. However, these cases are not strong enough and their hermetic seals can be easily unsealed, especially when diving to the deep water. In addition, at the deep water the cellular phone buttons are pressed due to the strong pressure, disabling the use of said buttons.

In the last years, several solutions have been proposed for employing photo and video cameras under the water. For example, U.S. Pat. No. 6,819,866 discloses a watertight housing for use underwater with a range of different video cameras. The watertight universal housing has a sealable internal cavity, which is adapted to receive a remotely controllable electronic device, a programmable controller, and an electromagnetic signal transmitter in the housing, which is controlled by the programmable controller. The programmable controller is designed to receive a command to control the remotely controllable electronic device from a command-providing device. However, U.S. Pat. No. 6,819,866 does not teach how to utilize a cellular phone with a camera and/or GPS means for various water activities, such as taking underwater pictures, shooting underwater video films, communicating and navigating under the water, while enabling a user to easily control said cellular phone. In addition, U.S. Pat. No. 6,819,866 does not teach how to enable said user to use different kinds of cellular phone within the same waterproof housing.

Another patent, U.S. Pat. No. 5,305,030, disclosed a camera case which permits underwater video shooting and which is also useful in video shooting on the ground when a hand grip assembly is detached therefrom. In the event of underwater video shooting, a video camera is placed in a main case body, and grips are attached to the case through a link plate. The grip has the function of a remote commander, transmitting infrared control signals from an LED to a signal receiver within a transparent window on the camera case to operate the camera accordingly. Still another application, US 2002/0003584, presents a digital underwater camera, which is hermetically sealed, being cast into a clear plastic totally without seams, seals or O-rings. According to US 2002/0003584, no penetrating wires are needed to control the camera; digital electrical signals for downloading image information from the camera being converted to infrared optical or, most preferably, radio signals that are communicated through the clear housing to an infrared or radio receiver, which in turn preferably connects to a picture-capturing personal computer with operating software. A further patent, U.S. Pat. No. 6,128,441, discloses a waterproof case for housing a camera therein, provided with an operation part which is disposed on said waterproof case, and a signal transmission circuit which is arranged to transmit a signal output of said operation part to the camera housed in the waterproof case. However all these publications, similarly to U.S. Pat. No. 6,819,866, do not teach how to utilize a cellular phone with a camera and/or GPS means for various water activities, such as taking underwater pictures, shooting underwater video films, communicating and navigating under the water. In addition, these publications do not teach how to enable said user to unitize different kinds of cellular phone within the same waterproof housing.

It is an object of the present invention to provide a method and system for enabling a user, when being under or above water, to take photographs and/or to shoot underwater video films by means of his cellular phone, overcoming all prior art drawbacks.

It is another object of the present invention to provide a method and system for enabling a user to navigate under or above water by means of his cellular phone having GPS means.

It is another object of the present invention to provide a method and system for enabling a user, when being under or above water, to communicate with another person by sending and receiving text and/or voice messages, photographs and/or video films.

It is still another object of the present invention to enable a user to utilize different types of cellular phones within the same waterproof case.

It is still another object of the present invention to provide a method and system, which is reliable, efficient and ensures that no water penetrates inside the waterproof case, even when diving to the deep water.

It is a further object of the present invention to provide a method and system, which is relatively inexpensive.

It is still a further object of the present invention to provide a method and system, which is user friendly.

Other objects and advantages of the invention will become apparent as the description proceeds.

### SUMMARY OF THE INVENTION

The present invention relates to a method and system for acquiring underwater photographs and/or video films, navigating and communicating under or above water by means of a cellular phone.

The system for carrying out water activities under or above water comprises: (a) a cellular phone for enabling a user to carry out water activities; (b) a waterproof case having a front section and a back section, said waterproof case being suitable to contain said cellular phone, said back section comprising a control button(s) panel, including one or more control buttons, for remotely controlling said cellular phone; and (c) an electronic circuit, programmed according to the cellular phone type, for processing data for controlling said cellular phone by means of said one or more control buttons and for forwarding said data to said cellular phone, said electronic circuit communicating with both said cellular phone and said control button(s) panel.

Preferably, the water activities are selected from the group, comprising: (a) taking photographs; (b) shooting video films; (c) sending text messages; (d) sending voice or audio messages; (e) sending photographs, images and video films; (f) recording voice, audio and video data; (g) navigating by means of GPS; and (h) sending and receiving GPS coordinates and maps.

Preferably, the cellular phone comprises a photo or video camera suitable for taking one or more photographs and/or shooting one or more video films.

Preferably, the front section comprises a waterproof transparent opening for enabling the cellular phone camera to take the one or more photographs or shoot the one or more video films with a desired field of view.

Preferably, the system further comprises a supporting base for stabilizing and calibrating the cellular phone with the waterproof transparent opening.

Preferably, the electronic circuit communicates with the cellular phone and the control button(s) panel by at least one data communication means selected from the group, comprising: (a) USB; (b) Bluetooth; (c) Wi-Fi; (d) Infrared IrDA; (e) Infrared IrSimple; (f) Serial Port; and (g) Wireless USB.

Preferably, the cellular phone further comprises a GPS component for navigating under or above water.

Preferably, the waterproof case further comprises a microphone for enabling the user to record voice or other audio data.

Preferably, the waterproof case further comprises a microphone for enabling the user to communicate by voice with a distant person.

Preferably, the cellular phone further comprises memory means for storing data, including but not limited to photographs, video films, voice, audio and textual data.

Preferably, the system further comprises a keypad panel provided on the back section of the waterproof case to allow a user to send data, including but not limited to one or more photographs or video films, and/or one or more text messages, voice or audio messages to a distant person.

Preferably, the data is sent to a cellular or digital phone of a distant person, or to an email or other electronic address of said distant person.

Preferably, the data is sent to a distant person in real-time.

Preferably, the back section of the waterproof case further comprises a display for displaying a distant person's phone number or email address, or for displaying one or more photographs, video films, maps, GPS coordinates or text messages.

The method of using a cellular phone in water activities under or above water comprises: (a) providing a cellular phone for enabling a user to carry out water activities; (b) providing a waterproof case having a front section and a back section, said waterproof case being suitable to contain said cellular phone, said back section comprising a control button(s) panel, including one or more control buttons, for remotely controlling said cellular phone; and (c) providing an electronic circuit being programmed according to the cellular phone type, for processing data for controlling said cellular phone by means of said one or more control buttons and for forwarding said data to said cellular phone, said electronic circuit communicating with both said cellular phone and said control button(s) panel.

Preferably, the method further comprises selecting the water activities from the group, comprising: (a) taking photographs; (b) shooting video films; (c) sending text messages; (d) sending voice or audio messages; (e) sending photographs, images and video films; (f) recording voice, audio and video data; (g) navigating by means of GPS; and (h) sending and receiving GPS coordinates and maps.

Preferably, the method further comprises taking one or more photographs and/or shooting one or more video films by means of a photo or video camera provided within the cellular phone.

Preferably, the method further comprises enabling the cellular phone camera to take the one or more photographs or shoot the one or more video films with a desired field of view by providing a waterproof transparent opening in the front section of the waterproof case.

Preferably, the method further comprises stabilizing and calibrating the cellular phone with the waterproof transparent opening by means of a supporting base.

Preferably, the method further comprises communicating with the cellular phone and the control button(s) panel by means of the electronic circuit using at least one data communication means selected from the group, comprising: (a) USB; (b) Bluetooth; (c) Wi-Fi; (d) Infrared IrDA; (e) Infrared IrSimple; (f) Serial Port; and (g) Wireless USB.

Preferably, the method further comprises navigating under or above water by means of a GPS component provided within the cellular phone.

Preferably, the method further comprises providing a microphone within the waterproof case for enabling the user to record voice or other audio data.

Preferably, the method further comprises communicating by voice with a distant person using a microphone provided within the waterproof case.

Preferably, the method further comprises storing data on memory means provided within the cellular phone, said data including but not limited to photographs, video films, voice, audio and textual data.

Preferably, the method further comprises providing a keypad panel on the back section of the waterproof case allowing sending data, including but not limited to one or more photographs, video films, voice, audio and textual messages to a distant person.

Preferably, the method further comprises sending the data to a cellular or digital phone of a distant person, or to an email or other electronic address of said distant person.

Preferably, the method further comprises sending the data to a distant person in real-time.

Preferably, the method further comprises displaying a distant person's phone number or email address, or displaying one or more photographs, video films, maps, GPS coordinates or text messages by means of a display provided on the back section of the waterproof case.

### BRIEF DESCRIPTION OF THE DRAWINGS

In the drawings:

FIG. 1A and FIG. 1B are schematic illustrations of a waterproof case for using a conventional cellular phone with a camera in water activities, according to a preferred embodiment of the present invention;

FIG. 2A is another schematic illustration of a waterproof case, showing units and components being installed within said case, according to a preferred embodiment of the present invention; —FIG. 2B is still another schematic illustration of a waterproof case showing units and components being installed within said case, according to another preferred embodiment of the present invention;

FIG. 2C is still another schematic illustration of a waterproof case, showing units and components being installed within said case, according to still another preferred embodiment of the present invention;

FIG. 3 is a schematic illustration of an electronic circuit (or chip) for enabling controlling user's cell phone by means of one or more control buttons, and being programmed in accordance with a user's cell phone type, according to a preferred embodiment of the present invention;

FIG. 4 is a further schematic illustration of waterproof case for utilizing a conventional cellular phone with a camera in water activities, according to a further preferred embodiment of the present invention; and

FIG. 5 is a still further schematic illustration of waterproof case for utilizing a conventional cellular phone with a camera and GPS in water activities, according to a still further preferred embodiment of the present invention.

### DETAILED DESCRIPTION OF THE PREFERRED EMBODIMENTS

Hereinafter, when the term “cell phone” is mentioned, it should be understood that it refers to the terms “mobile phone” and “cellular phone”, which are used interchangeably. In addition, wherein the term “water activity” is used it refers to any activity that can be carried out under or above water by means of a cellular phone utilizing features and capabilities of said cellular phone, such as taking photographs, shooting video films, sending text, image, video and voice/audio messages, navigating by means of GPS, etc.

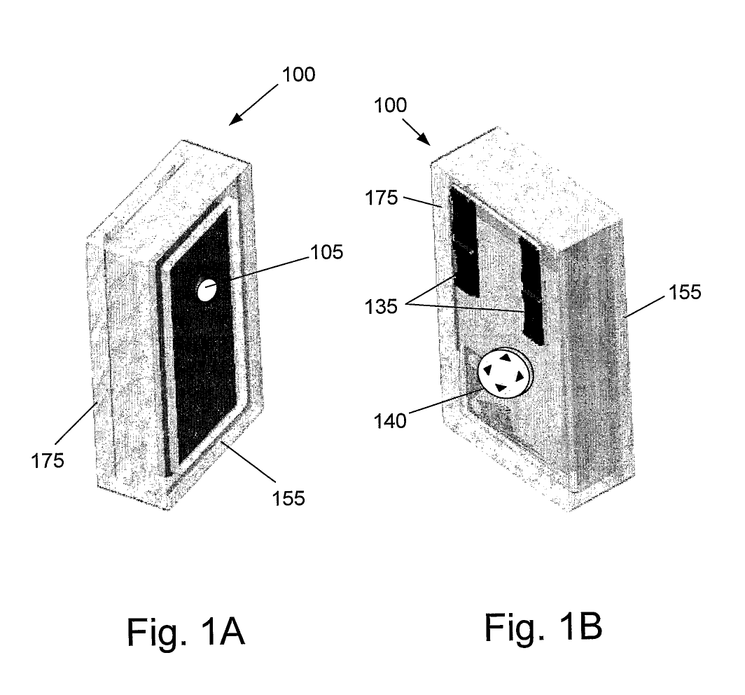

FIG. 1A and FIG. 1B are schematic illustrations of a waterproof case 100 for using a conventional cellular phone with a camera in water activities, according to a preferred embodiment of the present invention. The cellular phone is inserted inside said case 100 and is waterproof protected. Waterproof case 100 has a front section 155 and a back section 175. The camera of the cell phone, inserted in said case 100, is located in front of waterproof transparent opening 105 in said front section 155. Back section 175 is provided with one or more control buttons 135. A user can easily control the operation of said cellular phone by means of said control button(s) 135. For example, said user can send a command(s) to his cell phone inside waterproof case 100 to take a photograph, to shoot a video-film, to zoom or unzoom an underwater scene, etc. Optionally, waterproof case 100 can be provided with an additional control button(s) 140 providing to said user additional features for controlling his cell phone within said waterproof case 100.

It should be noted, that waterproof case 100 can have any size or form, such as a rectangular, triangular or circular form.

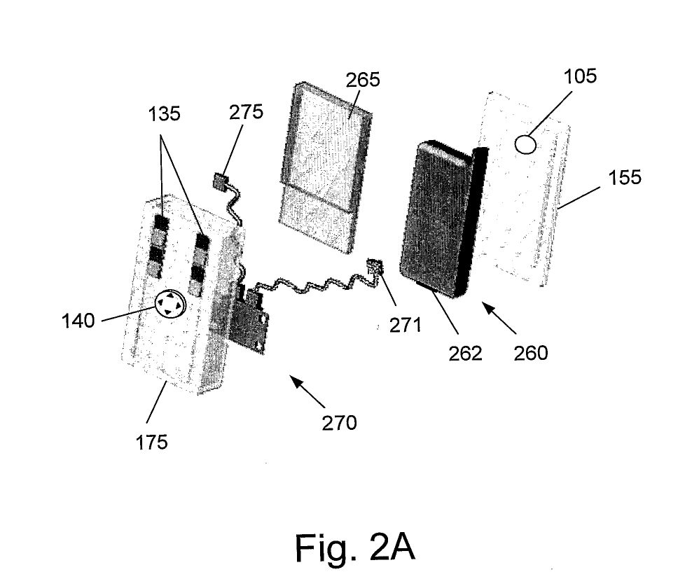

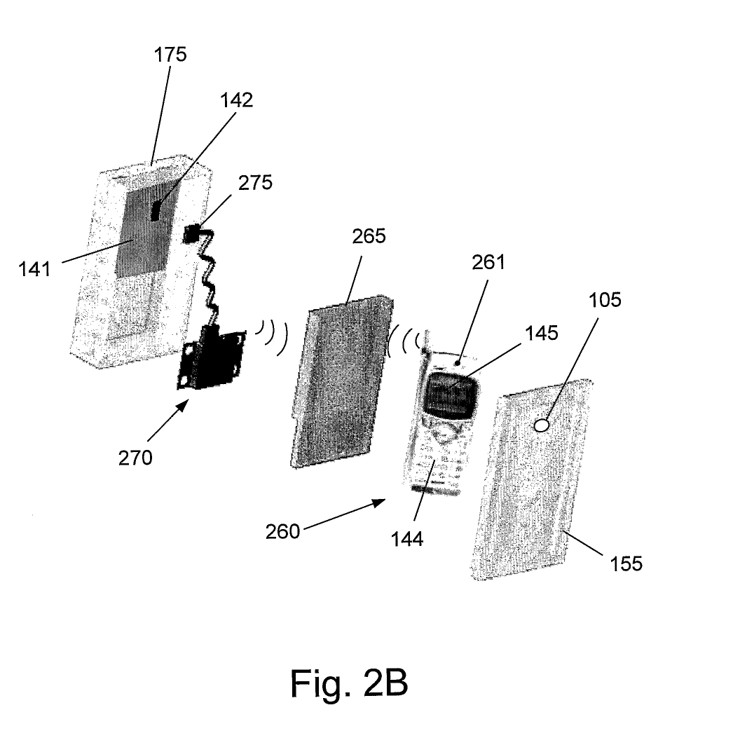

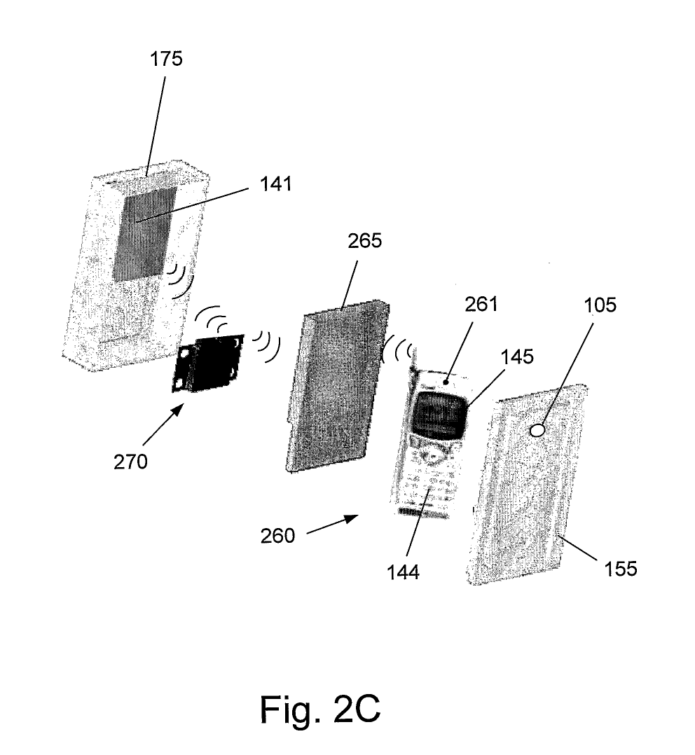

FIG. 2A is another schematic illustration of waterproof case 100 (as shown on FIG. 1A and FIG. 1B), showing units and components being installed within said case 100, according to a preferred embodiment of the present invention. Inside waterproof case 100, having front section 155 and back section 175, are installed the following components: a conventional cellular phone 260, having a camera, for taking photographs and/or for shooting video films; a supporting base 265 for stabilizing and calibrating said cellular phone 260 within said waterproof case 100; and a programmable electronic circuit (or chip) 270 being programmed, according to user's cell phone type, and connected to both cell phone 260 and control button(s) 135 and/or 140.

Electronic circuit 270 can be programmed and reprogrammed again, according to user's cellular phone type, such as the Nokia® 3220, Nokia® 3600, Motorola® MPx220, Samsung® E715, etc. According to a preferred embodiment of the present invention, the user wishing to use his cellular phone in water activities, first has to initialize said electronic circuit 270 by connecting it to his computer and programming it by downloading and/or installing on said electronic circuit 270 a dedicated file(s) or program. The user connects electronic circuit 270 to his computer by means, for example, one of USB (Universal Serial Bus) connectors 271 or 275 of said electronic circuit 270. Then the user surfs to a dedicated Web Site by means of his Web Browser and downloads to his computer or directly to electronic circuit 270 a corresponding plug-in relating to his cellular phone type. Then the user installs (if necessary) this plug-in on his electronic circuit 270. The downloaded plug-in comprises data related to operating user's cellular phone 260 by means of control button(s) 135 and/or 140, including data relating to possible ways for communicating with said cellular phone, such as by means of the USB and/or Infrared IrDA (Infrared Data Association) and/or Infrared IrSimple (IrSimple (Infrared Simple) is a High-Speed Infrared Communications Protocol Adopted as a Global Standard) and/or Wireless USB communication, etc. In addition, the plug-in comprises data relating to various features of user's cellular phone 260, such as an ability to zoom or unzoom an object being photographed, an ability to navigate by means of GPS which can be provided within said cellular phone, an ability communicate by means of text, image, video and audio/voice messages, etc. Alternatively, the user when purchasing waterproof case 100 can be provided with a disk (or any other storage media) comprising a plurality of plug-ins for different cellular phones types, and then he can download and/or install on said electronic circuit 270 from said disk a dedicated plug-in, relating to his cell phone type. The waterproof case 100 can have any dimensions. For example, for utilizing a cellular phone of “Nokia® 6100” model, waterproof case 100 can have a height of 12 centimeters, a length of 6 centimeters, and a width of 3.5 centimeters.

According to another preferred embodiment of the present invention, the user connects electronic circuit 270 to a display or monitor for downloading and installing the dedicated plug-in on said electronic circuit 270. Then he selects, downloads and installs the corresponding plug-in by means of control button(s) 135 and/or 140 of waterproof case 100.

It should be noted, that according to a preferred embodiment of the present invention, instead of USB connectors 271 and/or 275 can be used any type of connectors, such as a Serial Port connector, etc.

After initializing electronic circuit 270, the user inserts it to waterproof case 100, as shown on FIG. 2A along with his cell phone 260. The user connects connector 271, such as the USB, Serial Port connector of electronic circuit 270 to connector 262 his cell phone 260. Similarly, the user connects connector 275, such as the USB, Serial Port connector of electronic circuit 270 to connector 142 (FIG. 2B) of control button(s) panel 141 (FIG. 2B), enabling controlling said cellular phone 260 by means of control button(s) 135 and/or 140 and by means of said electronic circuit 270. In addition, according to a preferred embodiment of the present invention, supporting base 265 is inserted in waterproof case 100 for stabilizing and calibrating cellular phone 260 within said waterproof case 100 and ensuring that a camera objective 261 (FIG. 2B) of said cellular phone 260 is located directly in front of waterproof transparent opening 105 in said front section 155. After waterproof case 100 is hermetically sealed by connecting front section 155 to back section 175, said case 100 is ready for use in the underwater photography. The user can now remotely control his cell phone various features, such as the photo/video camera operation by control button(s) 135 and/or 140. The user can take underwater photographs, shoot underwater video films, zoom and unzoom underwater scenes and perform any other operations, which can be enabled in said cell phone 260, such as navigating by means of GPS, etc.

FIG. 2B is another schematic illustration of a waterproof case 100 (as shown on FIG. 1A and FIG. 1B), showing units and components being installed within said case 100, according to another preferred embodiment of the present invention. According to this embodiment, electronic circuit 270 in addition to a wire communication means, such as the USB, has a wireless communication means, such as the Infrared IrDA and/or Infrared IrSimple and/or Wireless USB, etc. for communicating with user's cell phone 260. Therefore, the user does not need to connect connector 271 (FIG. 2A) to cell phone connector 262. The user only need to connect connector 275 of said electronic circuit 270 to connector 142 (FIG. 2B) of control button(s) panel 141 (FIG. 2B). In addition, similarly to FIG. 2A, supporting base 265 is inserted in waterproof case 100 for stabilizing and calibrating cellular phone 260 within said waterproof case 100 and ensuring that a camera objective 261 of said cellular phone 260 is located directly in front of waterproof transparent opening 105 in said front section 155. After waterproof case 100 is hermetically sealed by connecting front section 155 to back section 175, said case 100 is ready for use in the underwater photography. The user controls his cell phone 260 operations by means of control button(s) 135 and/or 140 (FIG. 2A).

It should be noted, that according to a preferred embodiment of the present invention, electronic circuit 270 communicates with cell phone 260 and/or with control button(s) panel 141 by means of any type of wireless or wire communication. The types of wireless communication comprise Infrared IrDA, Infrared IrSimple, Wireless USB, Bluetooth, Wi-Fi (Wireless Fidelity), etc.

The following list contains, for example, different models of cellular phones with a camera having various data communication means:
Cellular phone 260 having the USB data communication means can be for example, “Samsung® E730” and “Samsung® SGH-E620” of the Samsung® company, “LG® T5100” of the LG® company, “Nokia® 7610” of the Nokia® company, “Sony® Ericsson® Z600” and “Sony® Ericsson® K700i” of the Sony® Ericsson® Mobile Communications company, etc.;
Cellular phone 260 having the Infrared (IrDA or IrSimple) data communication means can be for example, “Sony® Ericsson® Z600” and “Sony® Ericsson® K700i” of the Sony® Ericsson® Mobile Communications company, “Nokia® Communicator 9210i” of the Nokia® company; etc.;
Cellular phone 260 having the Serial Port data communication means, can be for example, “Nokia® Communicator 9210i” of the Nokia® company;
Cellular phone 260 having the Bluetooth data communication means can be for example, “Motorola® MPx220” of the Motorola® company, “Nokia® 7610” of the Nokia® company; “Sony® Ericsson® Z600” and “Sony® Ericsson® K700i” of the Sony® Ericsson® Mobile Communications company, “Motorola® A1000” of the Motorola® company, “Samsung® SGH-E620” of the Samsung® company, etc.; and
Cellular phone 260 having the Wi-Fi data communication means can be for example, “Nokia® Communicator 9500” of the Nokia® company.

FIG. 2C is still another schematic illustration of a waterproof case 100 (as shown on FIG. 1A and FIG. 1B), showing units and components being installed within said case 100, according to still another preferred embodiment of the present invention. According to this embodiment, electronic circuit 270 communicates with both user's cell phone 260 and control button(s) panel 141 by means of wireless communication, such as the Infrared IrDA and/or Infrared IrSimple and/or Wireless USB, etc. Therefore, the user do not need to connect both connectors 271 and 275 (FIG. 2A) to cell phone connector 262 and to control button(s) panel 141 connector 142 (FIG. 2B), respectively. Control button(s) panel 141 and electronic circuit 270 both comprise wireless data communication means, such as the Infrared IrDA, Infrared IrSimple and/or Wireless USB.

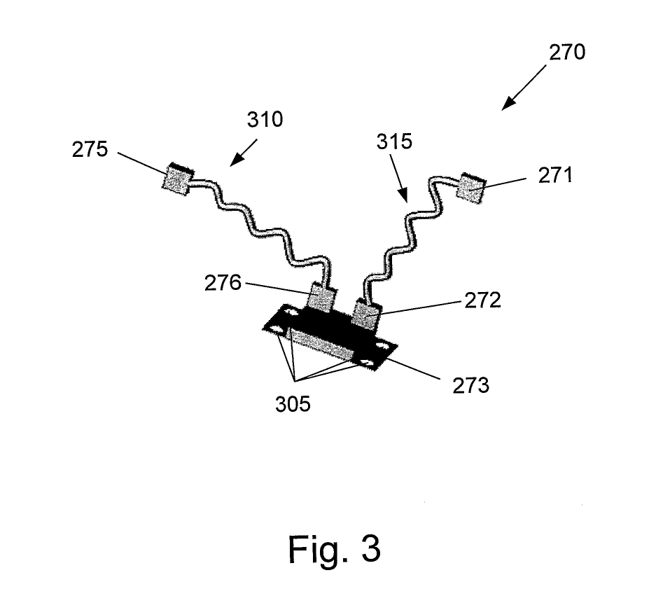

FIG. 3 is a schematic illustration of electronic circuit (or chip) 270 for enabling controlling user's cell phone by means of control button(s) 135 and/or 140 (FIG. 2A), and being programmed in accordance with a user's cell phone type, according to a preferred embodiment of the present invention. Electronic circuit 270 has a body 273, comprising all necessary electronic units and components for performing all necessary processing tasks for enabling the user to remotely control his cell phone 260 (FIG. 2A) by means of control button(s) 135 and/or 140 (FIG. 2A). In addition, electronic circuit 270 can comprise connector 271 and connector 275 for connecting to cellular phone 260 (FIG. 2A) and to control button(s) panel 141 (FIG. 2A), respectively. Connectors 271 and 275 can be any type of connectors, such as the USB, Serial Port connectors, etc. Wires 310 and 315, comprising connectors 271, 272, 275 and 276, can be detached from electronic circuit body 273 upon the need. Electronic circuit 273 can be connected to waterproof case 100 by means of screwing through one or more openings 305. In addition, it can be connected or attached to waterproof case 100 by a scotch tape, adhesively or by any other way.

According to a preferred embodiment of the present invention, electronic circuit 273 comprises one or more processing units and/or components, such as a microcontroller, microprocessor, ASIC (Application-Specific Integrated Circuit), DSP (Digital Signal Processor) or CPU (Central Processing Unit) for performing all necessary processing tasks for enabling the user to remotely control his cell phone 260. After the user downloads from the dedicated Web Site the corresponding plug-in, relating to his cellular phone type, said plug-in can be downloaded and/or installed into the firmware of said processing unit(s) and/or component(s). In addition, electronic circuit 273 can comprise memory means for storing said corresponding plug-in, or for any other purposes. In addition, electronic circuit 273 comprises data communication means, such as the Infrared IrDA, Infrared IrSimple, Wireless USB, Bluetooth, Wi-Fi (Wireless Fidelity) and etc. for communicating with cellular phone 260 and/or control button(s) panel 141.

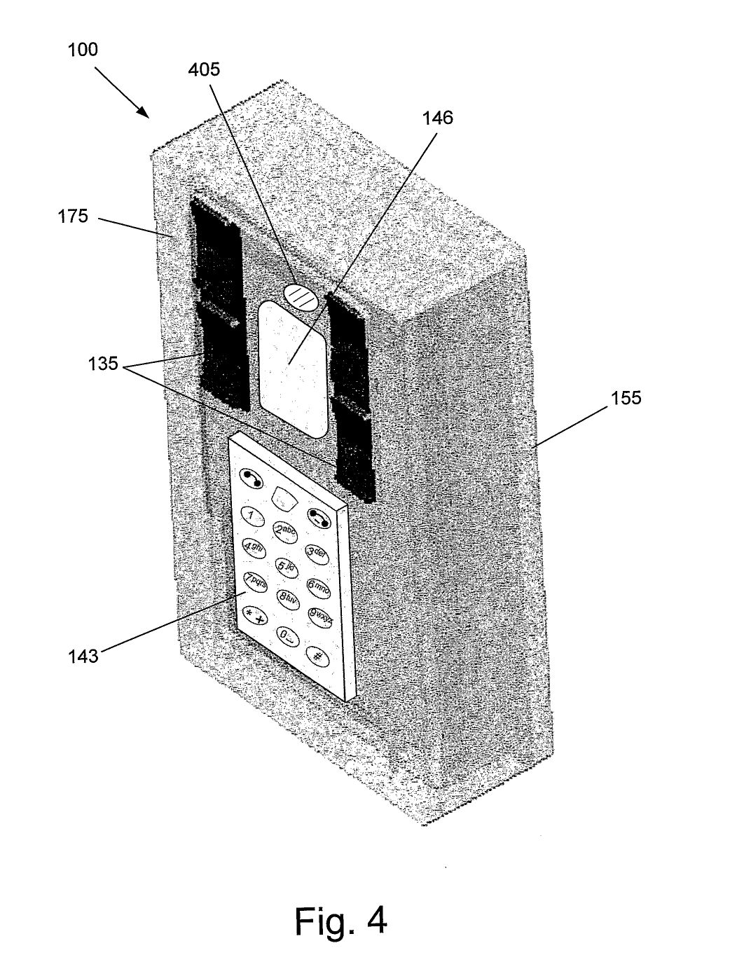

FIG. 4 is a further schematic illustration of waterproof case 100 for utilizing a conventional cellular phone with a camera in water activities, according to a further preferred embodiment of the present invention. The user, while taking photographs and/or shooting video films, by means of his cellular phone 260 (FIG. 2B) located within waterproof case 100, can send these photographs and/or video films in real-time to a distant person by using a keypad panel 143, located on back section 175 of said waterproof case 100. Said keypad panel 143 is a conventional keypad panel, which is similar to keypad panel 144 (FIG. 2B), as provided with conventional cellular phone 260. The user dials distant observer's phone number or inserts distant observer's email address by means of said keypad panel 143, and then sends him one or more underwater photographs and/or video films. Optionally, on back section 175 of waterproof case 100 can be located a display 146 (monitor, indicator or the like), displaying to the user the observer's phone number(s) or email address(es). The user can select the distant observer's phone number or email address from the memory unit of his cellular phone 260 by means of keypad panel 143, and then he can send to the selected phone number or email address one or more underwater photographs and/or video films. Keypad panel 143 and, optionally, display 146 enable the user to utilize all features and functions of said cellular phone 260. The user, when using keypad panel 143 and display 146, utilizes his cellular phone 260 similarly to utilizing it directly from keypad panel 144 (FIG. 2B) of said cellular phone 260. Furthermore, the photographed picture and/or shot video films can be displayed to the user on said display 146, similarly to displaying them on display 145 (FIG. 2B) of cellular phone 260.

In addition, according to another preferred embodiment of the present invention, the user while being underwater, instead of inserting a complete distant observer's phone number or email address, can use a predetermined shortkey on keypad panel 143 for sending a photograph(s) and/or video-film(s) to said distant observer. For example, the user after selecting the photograph(s) and/or video-film(s) to be sent to the distant observer, holds the key “1” on keypad panel 143 for a couple of seconds, and then said selected photograph(s) and/or video-film(s) is automatically sent to the distant observer. Similarly, by holding the key “2” said selected photograph(s) and/or video-film(s) is automatically sent to another distant observer.

It should be noted, that said photograph(s) and/or video-film(s) is sent by cellular phone 260 to a cellular or digital phone, or to an email address of said distant observer through a conventional Cellular Services Provider and in addition, optionally, through a conventional Wire Services Provider. Also it should be noted, that underwater photographs and video films can be send to the distant observer not only in real-time, but whenever the user wishes so.

According to another preferred embodiment of the present invention, the user of waterproof case 100 can send to another person (to the cellular or digital phone, or to the email address of said another person) one or more text, voice and audio messages by means of his cell phone 260 using keypad panel 143 and microphone 405. On display 146 can be displayed one or more text message(s) to be sent to said another person. The user can send various voice or audio messages, such as whales or dolphins singing, etc.

It should be noted that according to a preferred embodiment of the present invention, the voice, audio and video data can be recorded on a memory unit of cell phone 260. Optionally, said voice, audio and video data can be recorded on an external memory unit connected to said cell phone 260 within waterproof case 100.

It should be noted that according to a preferred embodiment of the present invention, display 146, keypad panel 143 and microphone 405 are connected to control button(s) panel 141 (FIG. 2B). Control button(s) panel 141 can comprise processing means (such as a microcontroller, microprocessor, ASIC, DSP or CPU) in addition to processing means of electronic circuit 270 (FIG. 2A) for processing data inputted by means of keypad panel 143, microphone 405 and displayed by means of display 146.

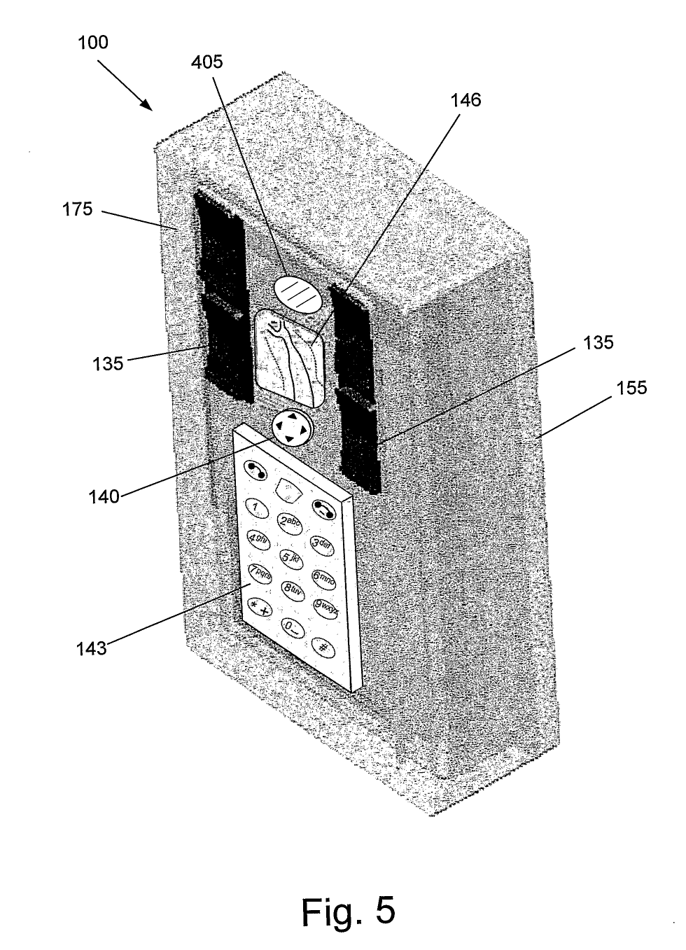

FIG. 5 is a still further schematic illustration of waterproof case 100 for utilizing a conventional cellular phone with a camera and GPS in water activities, according to a still further preferred embodiment of the present invention. Cell phone 260 (FIG. 2A) comprises GPS means for navigating under or above water. A user can navigate, for example, to various diving locations using a map or GPS coordinates displayed on display 146 of waterproof case 100. The user can scroll the map by means of button 140, zoom/unzoom the map and perform different operations related to GPS navigation by means of button(s) 135 and keypad panel 143. Waterproof case 100 enables the user to utilize his cell phone with the GPS means in various water activities. In addition, the user can send or receive maps or GPS coordinates from another person by means of his cell phone 260, located within waterproof case 100. Keypad panel 143, button 140 and display 146 enable the user to utilize all GPS functions of his cellular phone 260.

It should be noted, that buttons 140, 135 and keypad panels 143, 144 (FIG. 2B) are illustrated for the example only, and other buttons and panels can be used.

Also it should be noted that according to a preferred embodiment of the present invention, display 146, keypad panel 143, microphone 405 and button 140 are connected to control button(s) panel 141 (FIG. 2B). Control button(s) panel 141 can comprise processing means (such as a microcontroller, microprocessor, ASIC, DSP or CPU) in addition to processing means of electronic circuit 270 (FIG. 2A) for processing data inputted by means of keypad panel 143, microphone 405, button 140 and displayed by means of display 146.

It should be noted that all data, such as photographs, video films, text, voice and audio messages, GPS coordinates and maps can be stored in a memory unit of cellular phone 260. Optionally, cellular phone 260 can be provided with an additional external memory unit connected to said cellular phone 260 and located within waterproof case 100.

The cellular phone with GPS having data communication means can be, for example, Nokia® 3589i of the Nokia® company; Sony® Ericsson® T608 of the Sony® Ericsson® Mobile Communications company; Samsung® A650 of the Samsung® company; and many others.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for carrying out water activities under or above water, comprising:
a. a cellular phone for enabling a user to carry out water activities;
b. a waterproof case having a front section and a back section, said waterproof case being suitable to contain said cellular phone, said back section comprising a control button(s) panel, including one or more control buttons, for remotely controlling said cellular phone; and
c. an electronic circuit, programmed according to the cellular phone type, for processing data for controlling said cellular phone by means of said one or more control buttons and for forwarding said data to said cellular phone, said electronic circuit communicating with both said cellular phone and said control button(s) panel.

2. A system according to claim 1, wherein the water activities are selected from the group, comprising:
a. taking photographs;
b. shooting video films;
c. sending text messages;
d. sending voice or audio messages;
e. sending photographs, images and video films;
f. recording voice, audio and video data;
g. navigating by means of GPS; and
h. sending and receiving GPS coordinates and maps.

3. A system according to claim 1, wherein the cellular phone comprises a photo or video camera suitable for taking one or more photographs and/or shooting one or more video films.

4. A system according to claim 3, wherein the front section comprises a waterproof transparent opening for enabling the cellular phone camera to take the one or more photographs or shoot the one or more video films with a desired field of view.

5. A system according to claim 4, further comprising a supporting base for stabilizing and calibrating the cellular phone with the waterproof transparent opening.

6. A system according to claim 1, wherein the electronic circuit communicates with the cellular phone and the control button(s) panel by at least one data communication means selected from the group, comprising:
a. USB;
b. Bluetooth;
c. Wi-Fi;
d. Infrared IrDA;
e. Infrared IrSimple;
f. Serial Port; and
g. Wireless USB.

7. A system according to claim 1, wherein the cellular phone further comprises a GPS component for navigating under or above water.

8. A system according to claim 1, wherein the waterproof case further comprises a microphone for enabling the user to record voice or other audio data.

9. A system according to claim 1, wherein the waterproof case further comprises a microphone for enabling the user to communicate by voice with a distant person.

10. A system according to claim 1, wherein the cellular phone further comprises memory means for storing data, including but not limited to photographs, video films, voice, audio and textual data.

11. A system according to claim 1, wherein a keypad panel is provided on the back section of the waterproof case to allow a user to send data, including but not limited to one or more photographs or video films, and/or one or more text messages, voice or audio messages to a distant person.

12. A system according to claim 11, wherein the data is sent to a cellular or digital phone of a distant person, or to an email or other electronic address of said distant person.

13. A system according to claim 11, wherein the data is sent to a distant person in real-time.

14. A system according to claim 1, wherein the back section of the waterproof case further comprises a display for displaying a distant person's phone number or email address, or for displaying one or more photographs, video films, maps, GPS coordinates or text messages.

15. A method of using a cellular phone in water activities under or above water, comprising:
a. providing a cellular phone for enabling a user to carry out water activities;
b. providing a waterproof case having a front section and a back section, said waterproof case being suitable to contain said cellular phone, said back section comprising a control button(s) panel, including one or more control buttons, for remotely controlling said cellular phone; and
c. providing an electronic circuit being programmed according to the cellular phone type, for processing data for controlling said cellular phone by means of said one or more control buttons and for forwarding said data to said cellular phone, said electronic circuit communicating with both said cellular phone and said control button(s) panel.

16. A method according to claim 15, further comprising selecting the water activities from the group, comprising:
a. taking photographs;
b. shooting video films;
c. sending text messages;
d. sending voice or audio messages;
e. sending photographs, images and video films;
f. recording voice, audio and video data;
g. navigating by means of GPS; and
h. sending and receiving GPS coordinates and maps.

17. A method according to claim 15, further comprising taking one or more photographs and/or shooting one or more video films by means of a photo or video camera provided within the cellular phone.

18. A method according to claim 17, further comprising enabling the cellular phone camera to take the one or more photographs or shoot the one or more video films with a desired field of view by providing a waterproof transparent opening in the front section of the waterproof case.

19. A method according to claim 18, further comprising stabilizing and calibrating the cellular phone with the waterproof transparent opening by means of a supporting base.

20. A method according to claim 15, further comprising communicating with the cellular phone and the control button(s) panel by means of the electronic circuit using at least one data communication means selected from the group, comprising:
a. USB;
b. Bluetooth;
c. Wi-Fi;
d. Infrared IrDA;
e. Infrared IrSimple;
f. Serial Port; and
g. Wireless USB.

21. A method according to claim 15, further comprising navigating under or above water by means of a GPS component provided within the cellular phone.

22. A method according to claim 15, further comprising providing a microphone within the waterproof case for enabling the user to record voice or other audio data.

23. A method according to claim 15, further comprising communicating by voice with a distant person using a microphone provided within the waterproof case.

24. A method according to claim 15, further comprising storing data on memory means provided within the cellular phone, said data including but not limited to photographs, video films, voice, audio and textual data.

25. A method according to claim 15, further comprising providing a keypad panel on the back section of the waterproof case allowing sending data, including but not limited to one or more photographs, video films, voice, audio and textual messages to a distant person.

26. A method according to claim 25, further comprising sending the data to a cellular or digital phone of a distant person, or to an email or other electronic address of said distant person.

27. A method according to claim 25, further comprising sending the data to a distant person in real-time.

28. A method according to claim 15, further comprising displaying a distant person's phone number or email address, or displaying one or more photographs, video films, maps, GPS coordinates or text messages by means of a display provided on the back section of the waterproof case.

29-30. (canceled)
